(19) United States
(12) Patent Application Publication
(10) Pub. No.: US 2026/0140395 A1
(43) Pub. Date: May 21, 2026

(54) System and Method for Fitting Prescription Lenses to Smart Glasses

(71) Applicant: Optikam Tech, Inc., Montreal (CA)

(72) Inventors: Bassem El-Hajal, Montreal (CA); Marco Lancione, Montreal (CA); Piotr Szymborski, Montreal (CA)

(21) Appl. No.: 18/952,968

(22) Filed: Nov. 19, 2024

(51) Int. Cl. G02C 7/02; G02C 11/00

(52) U.S. Cl. CPC G02C 7/027; G02C 11/10

(57) ABSTRACT

A system and method for fabricating prescription lenses for smart glasses. Frames for smart glasses are selected and worn by a user. The electronics in the smart glasses are linked to a computer. The inclinometer within the smart glasses provides pantoscopic tilt angle data that indicates a combined angle of the frames and the head of the user. Data can be collected and processed as the user moves through various scenarios. The original lens prescription is altered to compensate for the pantoscopic tilt angle data, therein obtaining an altered prescription. The prescription lenses are formed using the altered prescription. In addition, the user can be imaged while wearing the frames. The images can be used to obtain ophthalmic measurements needed to properly fit the smart glasses with the prescription lenses. The imaging can be obtained using the camera within the smart glasses, by imaging in a mirror.

### BACKGROUND OF THE INVENTION

### 1. Field of the Invention

The present invention relates to the systems and methodologies used to properly fit prescription lenses into eyeglasses. More particularly, the present invention relates to systems and methods that fit prescription lenses into the complex structure of smart glasses.

### 2. Description of Background Art

in the growing age of technology, many companies, such as Apple®, Google® and Meta® have integrated electronics into eyeglasses. Such eyeglasses are commercially known as “smart glasses” in the electronics' industry and are exemplified by U.S. Pat. No. 9,285,592 Olsson and U.S. Pat. No. 9,075,249 to Heinrich. When smart glasses are sold to the public, the vast majority of smart glasses sold are selected from a limited number of frame types and lens types that are offered by the source company. The lenses in the smart glasses typically have no optical power.

Some companies enable a consumer to purchase customized smart glasses that contain prescription lenses. In such a scenario, a customer must have an existing eyeglass prescription and must forward the prescription to the manufacturer. The manufacturer creates lenses in accordance with the prescription and assembles those lenses into the smart glasses. The peripheral dimensions of the lenses cannot be changed because the lenses must be fit into the complicated assembly of the smart glasses. The initial prescription is obtained in the standard manner. That is, the prescription is obtained from vision tests performed by an optometrist or similar eyecare professional. However, when the eyeglass prescription is created, the dimensions of the lenses used within smart glasses are not considered. Thus, certain measurements must be obtained to compensate for the dimensional requirements and glass types of lenes used in smart glasses.

In order for prescription lenses to be most effective, the manufacturing of the lenses should take into account the dimensions and shape of the frames to which the prescript ion lenses are going to be applied. Furthermore, custom fabrication of the lenses should also be varied to accommodate the anatomical features of the person who will wear the eyeglass frames. When prescription lenses are fitted for a particular set of frames and for a particular person, several measurements must be made in order to ensure that the prescription lenses are fabricated properly. The needed measurements are commonly referred to as “ophthalmic measurements” in the industry. Many of the needed ophthalmic measurements depend solely upon the style and model of the eyeglass frames selected. Other ophthalmic measurements depend upon the anatomy of the person being fitted. Still other ophthalmic measurements depend upon how the eyeglass frames sit upon the face when being worn in a normal manner and how an individual looks through their eyewear lenses when performing various daily activities.

In addition to a person's facial anatomy, the position of the head and the posture of the body also have significant effects on the proper fitting of eyeglasses. Few people have a fully erect posture and view their environment by only looking straight ahead. Rather, most people have a slight slouch. Furthermore, most people look slightly downward as they walk or when they sit. Some people also have a tendency to tilt their head to one side or another as they drive or read. Each one of these head positions causes a person to look through a slightly different section of the lenses in a set of eyeglasses.

In order to obtain all the anatomical measurements needed, eyeglass frames are worn by the wearer. An optician or other technician then uses a variety of instruments to quantify the measurement variables needed to properly create prescription lenses for those eyeglass frames on that person. However, when a consumer is purchasing smart glasses, this cannot be done. Due to the sophistication of the smart glasses, the smart glasses are not currently assembled in an eyeglass store or in an optometrist's office. Rather, smart glasses are assembled in the facilities of the smart glasses manufacturer. This is currently required because in smart glasses, electronic elements are integrated into, onto, and/or adjacent the lenses. The equipment needed to integrate the lenses into the frames is only found at the manufacturer's facilities. In future designs, it should be anticipated that the lenses of smart glasses will be made interchangeable and that prescription lenses can be manufactured and installed at in the facilities of an optometrist or other eyecare professional.

In the prior art, there are systems that enable an individual to purchase prescription eyewear in a remote fashion. Some prior art systems use virtual 3D models of both the user's face and of the eyeglass frames. The virtual eyeglass frames are then superimposed over the virtual face to assess aesthetics and fit. Such prior art systems are exemplified by U.S. Pat. No. 9,817,248 to Yang. These prior art systems are sufficient for viewing the way eyeglasses look on a person. However, such systems simply position virtual eyeglasses in front of a virtual face. There are no adjustments for how gravity causes the eyeglasses to rest on the nose or how a person orients his/her head. Accordingly, any measurements that are obtained from such virtual model systems are only estimates and are not completely accurate.

U.S. Patent Application Publication No. 2014/0257839 to Suter, and U.S. Pat. No. 10,831,042 to El-Hajal et al. show prior art systems that enable a person to buy prescription eyewear online. The systems take an existing prescription for eyewear and adapt the prescription to any set of eyeglass frames that are selected online by the user. However, these systems rely on imagery that is taken of the person wearing the eyeglasses. The images are taken at different angles that can offset the measurements being made.

In most smart glasses, there exist electronics that include various sensors and often a camera. The sensors include inclinometers and/or accelerometers. These sensors are typically used to detect the position of the head for the purposes of playing games or controlling various other running software. It has been discovered that the existing electronics in a set of smart glasses can be used to help obtain the ophthalmic measurements needed to properly fit the smart glasses with prescription lenses. The details of the invention are described and claimed below.

### SUMMARY OF THE INVENTION

The present invention is a system and method for fabricating prescription lenses for smart glasses, wherein the smart glasses are of the type that includes some form of an inclinometer. The smart glasses may, or may not, include a camera. To fabricate the lenses, a lens prescription is obtained for a user. Frames for smart glasses are selected from those commercially available. The user selects and wears the frames that are selected.

The electronics inherent in the smart glasses are linked to an external computing device, such as a PC computer, smartphone or tablet. The inclinometer within the smart glasses provides pantoscopic tilt angle data that indicates a combined angle of the frames and the head of the user to the vertical plane while the frames are being worn. Data can be collected and processed as the user wears the glasses during natural movements and/or is optionally asked to move through various simulated scenarios. The measurements used in the fabrication of the prescription lenses is altered in view of the collected data. The prescription lenses are formed for the smart glasses using the prescription and the corrected measurements.

In addition, the user can be imaged while wearing the smart glasses. The images can be used to obtain ophthalmic measurements needed to properly fit the smart glasses with the prescription lenses. The imaging can be obtained using an external camera or using the camera within the smart glasses, by imaging in a mirror.

### DETAILED DESCRIPTION OF THE DRAWINGS

For a better understanding of the present invention, reference is made to the following description of an exemplary embodiment thereof, considered in conjunction with the accompanying drawings, in which:

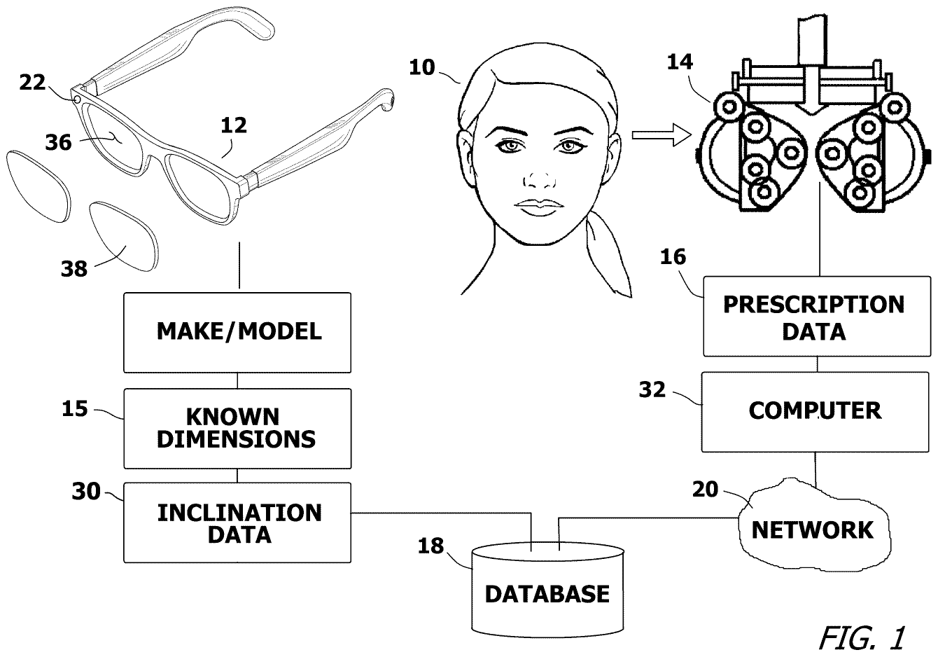

FIG. 1 is a block diagram schematic illustrating an exemplary system for obtaining data needed to accurately manufacture prescription lenses for smart glasses;

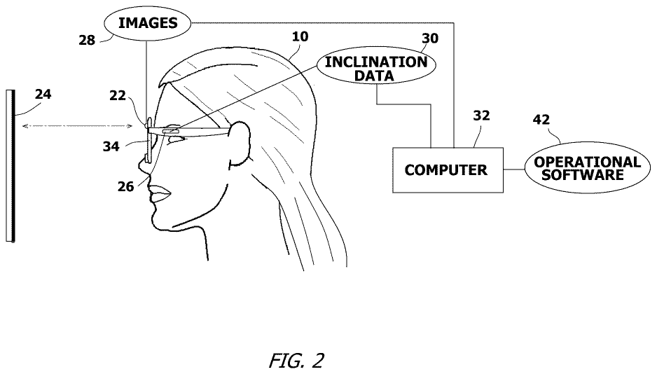

FIG. 2 is a block diagram schematic illustrating some imaging steps used to obtain data needed to accurately manufacture prescription lenses for smart glasses;

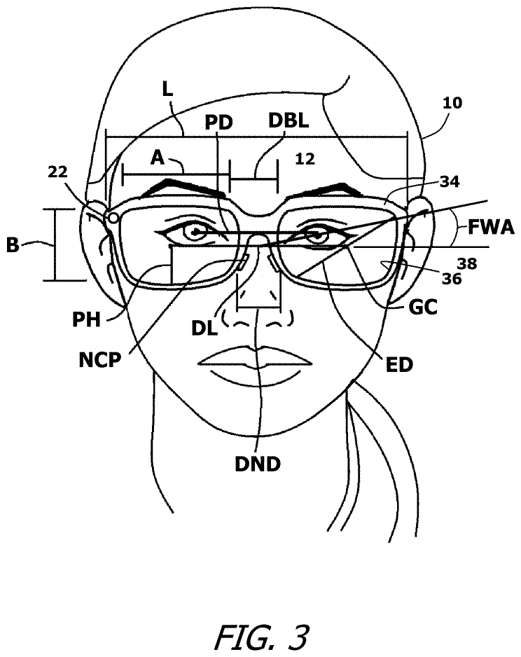

FIG. 3 is a front image of an individual wearing the frames of smart glasses and indicating some of the variables needed to be known for the proper fabrication of prescription eyewear;

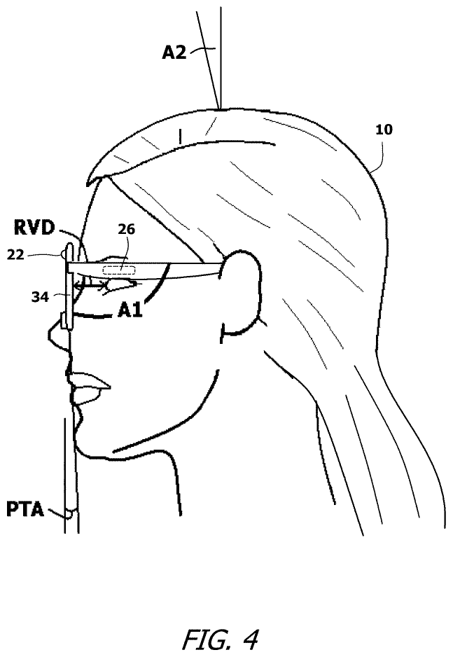

FIG. 4 is a side view of an individual wearing frames of smart glasses and indicating some of the variables needed for the proper fabrication of prescription eyewear; and

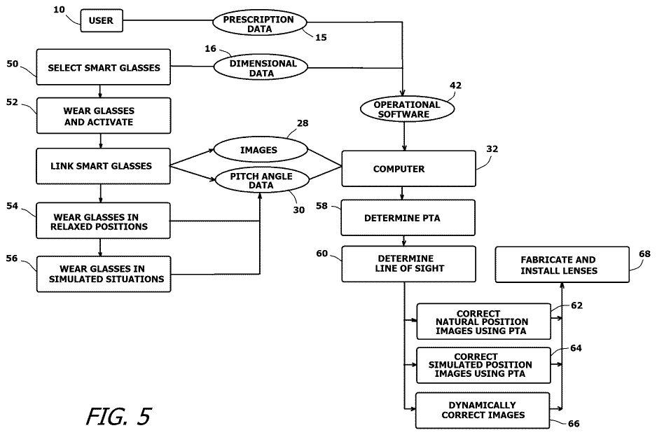

FIG. 5 is block diagram showing the methodology of the present invention system.

### DETAILED DESCRIPTION OF THE INVENTION

Although the present invention system and method can be used to accurately fabricate prescription lenses for a variety of smart glasses, only one exemplary embodiment of eyeglass frames is illustrated. This embodiment is exemplary and is intended to represent most all models and styles of smart eyeglasses. Accordingly, the model and style of the eyeglass frames in the exemplary embodiment is presented for education and discussion and should not be considered a limitation in the interpretation of the appended claims.

For the purposes of this description, “smart glasses” shall be considered all eyeglasses that have electronics that, among many features, can produce wearable data such as the angle of the eyeglass frames relative to the vertical plane. The smart glasses may or may not contain a camera. Referring to FIG. 1, it will be understood that a system user 10 who wants prescription lenses manufactured into a set of smart glasses 12 must first visit an optometrist or similarly qualified person in order to obtain a corrective lens prescription. Typically, an eye exam is conducted using diagnostic equipment 14, such as a phoropter. The diagnostic information obtained from the eye exam is used to generate prescription data 16. The prescription data 16 may be stored in a cloud accessible database 18 that is accessed through a data network 20, such as the Worldwide Web.

An eye exam need not be performed to use the present invention system. If prescription data 16 is required, the prescription data 16 can be obtained from records of old exams or even by analyzing the current eyewear of the user 10. It will therefore be understood that the prescription data 16 is obtained from some source and may be presented in many formats.

Once the prescription data 16 is obtained from some source, the user 10 selects the make and model of the smart glasses 12 into which the prescription lenses are to be mounted. The manufacturers of smart glasses typically offer only a few options in the frames of smart glasses. This is due to the electronics contained in smart glasses requiring certain dimensions that limit options in design.

Samples of smart glasses 12 are made available to the user 10 at a fitting. The models and sizes of the smart glasses 12 are known. Consequently, the dimensions 15 of the smart glasses 12 selected by the user 10 are known. Referring to FIG. 2 in conjunction with FIG. 1, it will be understood that the smart glasses 12 may contain a camera 22. In one exemplary embodiment, the user 10 who is being fitted for the smart glasses 12 is provided with, or has access to, a mirror 24. Using the mirror 24, the smart glasses 12 are capable of taking images 28 of the user 10 from the unique perspective of the eyes of the user 10. The mirror 24 can be placed at the level of a computer screen, placed at the level of a windshield, held like a book, or otherwise placed in a position that requires a common head posture. The images 28 can be taken by a secondary camera, such as a tablet computer, a mobile phone or the camara of a personal computer, if a mirror is unavailable or smart glasses do not contain a camera or when dispensing is performed by another person such as an optician.

The smart glasses 12 also contain one or more wearable sensor devices such as inclinometer(s) 26. The readings from sensor devices such as the inclinometers 26 can be obtained using a wireless link to the smart glasses 12. Sensor devices such as the internal inclinometer(s) 26 have the ability to measure a variety of wearable data such as an inclination angle of the smart glasses 12 relative to a reference plane. The inclinometer 26 collects and transmits wearable data such as inclination angle data 30 to a computer device 32. The computer device 32 can be a personal computer, a laptop computer, a tablet, a smartphone, smart glasses, and/or a server that is accessible through the data network 20.

Both the images 28 and wearable data such as the inclination angle data 30 obtained by the smart glasses 12 are used. The images 28 captured by the internal camera 22 are transferred to the computer device 32. The images 28 captured by the internal camera 22 are taken from the point of view of the eyeglass frames 34 of the smart glasses 12. Thus, the captured images 28 clearly show the physical features of the eyeglass frames 34 in relation to the anatomical features of the user's face. Likewise, the images 28 captured by the external camera such as one contained in a tablet computer, mobile phone or any computer device, taken by an assisting person such as an optician, clearly show the physical features of the eyeglass frames 34 in relation to the anatomical features of the user's face. External camera may also capture depth related information of the imaged subject as in case of depth capture cameras such as LiDAR or structured light.

Referring to FIG. 3 and FIG. 4 in conjunction with FIG. 1, it will be understood that certain measurements must be taken from the eyeglass frames 34 that reference the anatomy of the eyes and face. Collectively, some of the major variables that are needed to fabricate a set of prescription eyeglasses are present in Table 1, below.

TABLE 1

Frame Dimension Variables
A— Lens Length
B—Lens Height
ED—Effective Diameter
GC—Geometrical Centers
DL—Datum Line
L—Frame Length
DBL—Distance Between Lenses
FWA—Frame Wrap Angle
Anatomical Dependent Variables
PH—Pupil Height
PD—Pupil Distance
PTA—Pantoscopic Tilt Angle
RVD—Rear Vertex Distance

FIG. 3 is a front image of a person wearing eyeglass frames 34 of smart glasses 12. FIG. 4 is a side image of the same. The eyeglass frames 34 have lens openings 36 which can be fitted with prescription lenses 38 by the manufacturer. Referring to Table 1 in conjunction with FIG. 3 and FIG. 4, it will be understood that each model and style of eyeglass frames 34 has its own critical dimensions that need to be known in order to shape the prescription lenses 38 for the eyeglass frames 34. Those measurement variables include the overall peripheral shape of the eyeglass frames 34. Eyeglass frames 34 retain the prescription lenses 38 in a lens plane. Typically, the lens plane associated with smart glasses 12 are at a slight angle relative to the vertical. This tilt angle A1 is sometimes referred to as the “device panto” in the industry. The tilt of the lens plane is also affected by the tilt angle A2 of the person's head. This tilt angle A2 is caused by posture and the way a person holds his/her head.

Within the overall shape of the eyeglass frames 34, there are the lens length “A” and the lens height “B”. There is the effective diameter “ED” as measured through the geometric center “GC” of each lens 38. The geometric centers “GC” of both lenses 38 align horizontally on the datum line “DL”. The distance between the geometric centers “DBC” is the distance between the geometric centers “GC” in the horizontal plane. The frame length “L” is the distance between temples in the horizontal plane. The bridge size, or distance between lenses “DBL” is the minimum distance between the left and right lenses 38. The frame wrap angle “FWA” describes the horizontal angle of the lens plane in front of the eyes. The pantoscopic tilt angle “PTA” corresponds to the total vertical tilt of the lens plane. The proper pantoscopic tilt angle “PTA” for an individual is highly dependent upon the natural head posture of the individual. This is because the vertical plane being a constant and any downward tilt of the head directly changing the tilt of the eyeglass frames 34 relative the vertical plane. As such, the pantoscopic tilt angle “PTA” is the sum of the tilt angle A1 caused by the device panto plus the tilt angle A2 cause by head posture.

Other measurements that depend upon the anatomy of the person wearing the eyeglass frames 34 include pupil height “PH”, pupil distance “PD”, and rear vertex distance “RVD”. The pupil height “PH” is the measured height of the pupils above the bottom of the prescription lenses 38. The pupil distance “PD” is the distance between pupils in the horizontal plane. The rear vertex distance “RVD” is the gap distance between the pupil and the lens.

The pantoscopic tilt angle “PTA”, pupil height “PH” and the rear vertex distance “RVD” are measurements that depend upon how the prescription lens are held in front of the eyes. These measurements also depend upon how a person normally orients his/her head when looking through the prescription lenses 38, which determines the point on the lens where the line of sight of the person wearing the glasses passes through the lens. The measurements of Table 1 are readily obtained from images 28 of the smart glasses 12 when worn. For example, all the variables of Table 1 can be obtained from images 28 provided at least one of the known dimensions is taken from the dimensions of the frame 34 to be used as a reference scale.

What is not known is how much the user changes the orientation of his/her head when they read, drive, stand, walk, watch television, or otherwise perform ordinary tasks while wearing eyeglasses. Referring to FIG. 4, it can be seen that if a person has a slight slouch or downward head inclination, the tilt angle A2 affects the overall pantoscopic tilt angle “PTA” of the smart glasses 12 when worn. Variations to the pantoscopic tilt angle “PTA”, can also affect pupil height “PH” and rear vertex distance “RVD”. All three affect the line of sight through the prescription lenses 38.

Referring to FIG. 5 in conjunction with FIG. 1 through FIG. 3, the details of the operation of the present invention system 40 is described. In order to utilize the system 40, a make and model of smart glasses 12 are selected. See Block 50. The smart glasses 12 are worn by the user 10 and are activated. See Block 52. The smart glasses 12 electronically link to a remote computer device 32 that is running customized operational software 42. The smart glasses 12 can contain a camera 22 that can send images 28 to the computer device 32. The smart glasses can also be the computer device that runs the customized operational software and process the image internally without a remote computer. Alternatively, an image can be taken from a secondary camera in a separate device, such as a tablet computer or smartphone. The smart glasses 12 also contain one or more sensor devices such as an inclinometer 26 that can send inclination angle data 30 to the computer device 32. The user 10 is instructed to wear the smart glasses 12 in a comfortable position. An optician or qualified person may aid the wearer in adjusting the frame to ensure that the smart glasses form a proper comfortable fit to the wearer's face. The pre-fit frame adjustment may be noted and reproduced when the smart glasses are fabricated and provided to the user. Alternatively, a picture of the user's face may be taken to obtain facial measurements that can be used to select the proper frame size and to determine proper frame fit and frame adjustments. See Block 54. The user 10 is then asked to wear the smart glasses in a natural manner and/or participate in a situational simulation. See Block 56. If the wearer typically wears eyeglasses when sitting at a desk, the wearer is asked to sit at a desk. If the wearer typically wears eyeglasses when walking, the wearer is asked to walk. Similar situational simulations can be practiced for other activities, such as standing, reading and like. What is of importance is that the wearer wears the smart glasses 12 in the same or similar manner as they would in real life. Likewise, the wearer places his/her body in the same or similar position and holds his/her head in the same manner as they would in everyday life. Accordingly, the overall pantoscopic tilt angle “PTA” is true or similar to everyday life. Since the smart glasses 12 contain a camera 22, the system can take self-images during the situational simulations by simply looking into a mirror 24. The images 28 are taken from the point of view of the user's eyes. This unique perspective creates highly accurate images 28 with the information needed to fabricate accurate prescription lenses 38.

During the performance of the situational simulations, the smart glasses 12 collects positional data that identifies the changes in pantoscopic tilt angle “PTA” experienced by the smart glasses 12. This inclination angle data 30 is transmitted to the computer device 32 that runs the operational software application 42. The software application 42 then determines what pantoscopic tilt angle “PTA” represents the posture of the user during a given activity. See Block 58. Once the data that identifies the natural posture of the person is identified, some physical reference data can be obtained. The dimensions of the smart glasses 12 can be retrieved by the computer device 32 using the running operational software 42. The operational software 42 can access databases 18 that store physical dimensions for various makes and models of smart glasses 12. If the dimensions of the frames 34 are unknown or unavailable, the dimensions can be measured directly from the frames 34. Alternatively, measurements can be obtained by taking scaled measurements from the acquired images. With the known dimensions of the smart glasses 12 and the known pantoscopic tilt angle “PTA”, a corrected line of sight for a particular user 10 can be produced. See Block 60. This can be done using one of three options. Referring to Block 62, a first option is discussed. In this option, one or more images 28 of the wearer and the smart glasses 12 are taken. This can be done with a secondary camera or by using the camera 22 in the smart glasses 12 and a held mirror 24. The images 28 are taken during a period of time when the user is wearing the smart glasses 12 in a natural manner. That is, the user is holding his/her head in a natural manner during imaging. Initial measurements are taken from the images 28. The initial measurements are then corrected with the data from the sensor regarding the pantoscopic tilt angle “PTA”. This produces a final set of measurements. If the mirror 24 is used to obtain the images 28, the operational software 42 running in the computer device 32 can instruct a user how to properly orient the mirror 24 or the mirror is oriented mechanically. Alternatively, the smart glasses themselves can indicate when a proper reflected image is obtained. Once properly oriented, one or more images 28 of the user 10 and the smart glasses 12 can be taken.

Referring to Block 64, a second option is discussed. In this option, one or more images 28 of the wearer and the smart glasses 12 are taken. This can be done with a secondary camera or by using the camera 22 in the smart glasses 12 and a held mirror 24. The images 28 are taken as the user is instructed to perform certain simulations. That is, the user is imaged while performing the act of reading, watching television, driving, or the like. Once the images 28 are taken, the initial measurements are taken directly from the images 28. The initial measurements are then corrected with the data from the sensor regarding the pantoscopic tilt angle “PTA”. This produces a final set of measurements that can be used to properly fabricate the prescription lenses.

Referring to Block 66, a third option is discussed. In this option, one or more images 28 of the wearer and the smart glasses 12 are taken. This can be done with a secondary camera or by using the camera 22 in the smart glasses 12 and a held mirror 24. The images 28 are taken as the user is acting naturally and/or is instructed to perform certain simulations. As the images 28 are taken, the measurements obtained from the images are dynamically corrected with the data from the sensor regarding the pantoscopic tilt angle “PTA”. The automatic correction of measurements is conducted by the operational software 42 running in the computer device 32. This automatically produces a final set of measurements that can be used to properly fabricate the prescription lenses.

All three methodologies produce corrected measurements that correct for the true line of sight. The corrected measurements are then used to fabricate the lenses for the smart glasses. See Block 68.

It will be understood that the exemplary embodiment of the present invention system that is illustrated is merely exemplary and that many aspects of the system can be redesigned in manners that are functionally equivalent. All such variations, modifications and alternate embodiments are intended to be included within the scope of the present invention as claimed.

What is claimed is:

1. A method for fabricating prescription lenses for smart glasses, wherein the smart glasses are of the type that include a camera and an inclinometer, said method comprising the steps of:
obtaining a lens prescription for a user;
selecting frames for smart glasses from a selection of commercially available frames;
having said user wear said frames that are selected;
imaging said user to obtain at least one image, wherein initial measurements needed to fabricate said prescription lenses are obtained from said at least one image;
wherein said inclinometer within said smart glasses provides pantoscopic tilt angle data that indicates a combined angle of said frames and the head of the user;
altering said initial measurements to compensate for said pantoscopic tilt angle data, therein obtaining a modified measurements required to fabricate said prescription lenses.

2. The method according to claim 1, wherein said imaging the user wearing said frames is achieved using said camera in said smart glasses.

3. The method according to claim 1, wherein said imaging the user wearing said frames includes imaging the user in a mirror.

4. The method according to claim 1, wherein said imaging the user wearing said frames is achieved using a camera external of said smart glasses.

5. The method according to claim 1, further including having the user wear said frames during a period of natural body movements, wherein said pantoscopic tilt angle changes during said period, and wherein said inclinometer generates data corresponding to said changes in said pantoscopic tilt angle.

6. The method according to claim 1, further including having the user move through at least one situational simulation, wherein said pantoscopic tilt angle changes during said at least one situational simulation, wherein said inclinometer generates data corresponding to said changes in said pantoscopic tilt angle.

7. The method according to claim 1, wherein said altering said initial measurements includes altering said initial measurements from said at least one image after said at least one image is created.

8. The method according to claim 1, wherein said altering said initial measurements includes dynamically altering said initial measurements as said at least one image is being created.

9. The method according to claim 1, wherein said modified measurements includes measurements selected from a group comprising pupil distance, pupil height, lens length, lens height, effective diameter, distance between lenses, rear vertex distance, frame wrap angle and pantoscopic tilt angle.

10. A method of obtaining measurements needed to fabricate lenses for smart glasses that conform to a lens prescription, said method comprising the steps of:
providing frames for smart glasses into which said prescription lenses are to be set, wherein said frames contain a camera and electronics that provide inclination data;
wearing said frames, wherein said inclination data corresponds to said changes in orientation experienced while said frames are being worn;
imaging said frames while being worn to obtain at least one image;
obtaining initial measurements from said at least one image;
using said inclination data to modify at least some of said initial measurements, therein creating modified measurements, wherein said modified measurements are utilized in fabricating said lenses.

11. The method according to claim 10, wherein said initial measurements includes measurements selected from a group comprising pupil distance, pupil height, lens length, lens height, effective diameter, distance between lenses, rear vertex distance, frame wrap angle and pantoscopic tilt angle.

12. The method according to claim 10, further including providing a computer device separate from said smart glasses and having said smart glasses transmit said inclination data to said computer device.

13. The method according to claim 10, wherein said imaging said frames is achieved using said camera in said smart glasses.

14. The method according to claim 10, wherein said imaging the user wearing said frames is achieved using a camera external of said smart glasses.

15. The method according to claim 10, further including having the user wear said frames during a period of natural body movements, wherein said pantoscopic tilt angle changes during said period, and wherein said inclinometer generates said inclination data corresponding to said changes in said pantoscopic tilt angle.

16. The method according to claim 10, further including having the user move through at least one situational simulation, wherein said pantoscopic tilt angle changes during said at least one situational simulation, wherein said inclinometer generates said inclination data corresponding to said changes in said pantoscopic tilt angle.

17. The method according to claim 10, wherein said initial measurements are dynamically altered by said inclination data as said at least one image is being created.

18. A method of obtaining measurements needed to fabricate prescription lenses for smart glasses, said method comprising the steps of:
providing frames having lens openings into which said prescription lenses are to be set, wherein said frames house electronics that provide inclination data, wherein said inclination data detects changes in orientation of said frames including tilt angle relative to a vertical plane;
wearing said frames for a period of time, wherein said inclination data that corresponds to said changes in orientation experienced during said period of time; and
utilizing said inclination data to generate at least some final measurements sufficient to fabricate said prescription lenses.

19. The method according to claim 18, further including obtaining initial measurements that reference said frames and altering said initial measurements with said inclination data to produce a full set of final measurements sufficient to fabricate said prescription lenses.

20. The method according to claim 18, further including imaging said frames while being worn to obtain initial measurements and altering said initial measurements with said inclination data to obtain said at least; some final measurements.
